(19) United States
(12) Patent Application Publication
(10) Pub. No.: US 2011/0178610 A1
(43) Pub. Date: Jul. 21, 2011

(54) SYSTEMS AND METHODS FOR MANAGING UTILITY CONSUMPTION

(75) Inventors: Stephen D. O'Connor, Leawood, KS (US); Ronald C. Gamble, Altadena, CA (US); Richard A. Suchter, Arcadia, CA (US)

(73) Assignee: TERRATRIM, INC., Leawood, KS (US)

(21) Appl. No.: 13/120,920

(22) PCT Filed: Oct. 15, 2009
(86) PCT No.: PCT/US2009/060925

§ 371 Date: Mar. 25, 2011

Related U.S. Application Data
(60) Provisional application No. 61/107,465, filed on Oct. 22, 2008.

(51) Int. Cl. G05B 13/04; G06G 7/48

(52) U.S. Cl. 700/30; 703/6

(57) ABSTRACT

A system and method for monitoring and managing utility consumption includes use of (A) one or more sensors arranged to monitor an operating condition and/or utility consumption of at least one segment or appliance of a first facility; (B) a memory including at least one of (i) stored utility consumption information correlated or normalized to at least one designated parameter affecting utility consumption or (ii) hypothetical utility consumption; (C) a processor to compare the monitored information with the stored information, and (D) an output medium to store and/or display the comparison information. Stored consumption information may relate to the first facility or a second facility. Hypothetical utility consumption information may relate to a segment or appliance of the first facility operated according to optimized conditions, or an upgraded segment or appliance.

### STATEMENT OF RELATED APPLICATION(S)

This application claims benefit of U.S. Provisional Patent Application No. 61/107,465 filed on Oct. 22, 2008. The disclosure of such application is hereby incorporated by reference as if set forth fully herein.

### FIELD OF THE INVENTION

The present invention relates to managing consumption of utilities (e.g., electrical power, fuel, water, chemicals, and the like) by utility-consuming segments or appliances associated with facilities.

### DESCRIPTION OF THE RELATED ART

Various technologies exist to monitor consumption of utilities such as electric power, fuel (e.g., natural gas), water, chemicals, and the like. With respect to electric power monitoring in particular, the ease with which electric power may be monitored has led to significant development in this field. Conventional electric power monitoring technologies range from utility meters arranged to measure main circuit consumption for an entire facility, to plug-in devices adapted to monitor electric power consumption by specific electrical outlets or devices. Additionally, various methodologies and standards have been developed for electric power monitoring systems to communicate information to a central location. For example, the ZigBee Alliance has standardized certain wireless protocols capable of communicating electric power information, and ZigBee-enabled products such as the Alektrona Z-Aperture™ ZA07-200-ESP and the Landis+Gyr Focus AX provide metering and communication utility. Broadband-over-powerline (BPL) technology may also enable communication of electric power consumption information from an electric meter to a central location.

With respect to energy as a subset of utilities, it is well-accepted that conventional utility monitoring products and technologies have not been successful at helping utility users (e.g., consumers and businesses) actually reduce energy consumption, as the U.S. Dept. of Energy estimates that up to 25% of total energy consumption is wasted. With conventional utility monitoring technologies, a utility user typically has little idea whether consumption in a given period is high or low relative to consumption of other comparable users. Additionally, many utility users do not follow recommended guidelines for maintenance of utility-consuming appliance and/or replacement of inefficient appliances. For example, comparatively few utility users adhere to manufacturer-recommended regular maintenance of their air-conditioning systems. Thus, many users operate air conditioning systems in a sub-optimal maintenance state (e.g., low refrigerant, dirty condenser, dirty evaporator, dirty filters, etc.) for months or years until such systems finally break down. Similarly, utility users often neglect to replace or upkeep insulation, windows, refrigerators, furnaces, water heaters, and so on.

As worldwide population and utility consumption continues to expand (e.g., with an estimated 1.8 billion new middle class utility users by the year 2020), strains on worldwide utility resources will persist. Additionally, many utility providers are in the process of introducing smart energy meters to implement time-dependent pricing structures and communicate real-time information to the provider.

Utility conservation is a complex issue involving multi-dimensional factors (see FIG. 1). Simple tracking of utility consumption does little to help a utility user understand how to minimize wasteful utility consumption. For example, with respect to energy, actual energy consumption and/or energy cost may depend on multiple independent and dependent variables such as: appliance age, appliance condition, ambient temperature, ambient humidity, occupancy of a facility, thermal loading activity in or on a facility, changes in activities from historic levels, tiered total monthly energy use, etc. As consideration of all of these parameters may be required for a user to make intelligent decisions to minimize energy costs, and meaningful information accounting for these parameters is not readily available, most utility users simply ignore the issue altogether.

Thus, a primary obstacle to achieving meaningful utility conservation has been that utility users lack easy-to-understand and useful information to assist in managing utility usage.

Based on the foregoing, need exists for systems and methods for utility monitoring and management systems and methods that take into account variables that affect utility consumption, and present information to utility users in a meaningful way.

### SUMMARY OF THE INVENTION

In a first separate aspect, the invention relates to a system including (i) at least one sensor arranged to monitor any of an operating condition and utility consumption of at least one utility-consuming segment or appliance associated with a first facility; (ii) a memory including stored information indicative at least one of the following items: (a) historical utility consumption of said at least one segment or appliance associated with the first facility, correlated to at least one designated parameter affecting utility consumption; (b) utility consumption of at least one segment or appliance associated with a second facility, correlated to at least one designated parameter affecting utility consumption; (c) hypothetical utility consumption of said at least one segment or appliance associated with the first facility and operated according to optimized conditions; and (d) hypothetical utility consumption of a proposed replacement at least one segment or appliance that may be substituted for said at least one segment or associated with the first facility; (iii) a processor operatively arranged to receive information derived from the at least one sensor, and to compare the monitored information with the stored information so as to generate comparison information; and (iv) an output medium arranged to store and/or display said comparison information.

In another separate aspect, the invention relates to a method for performing at least one of utility consumption monitoring and management, the method including: (i) monitoring, with at least one sensor, any of an operating condition and utility consumption of at least one utility-consuming segment or appliance associated with a first facility; (ii) storing information indicative of at least one of the following: (a) historical utility consumption of said at least one segment or appliance associated with the first facility, correlated to at least one designated parameter affecting utility consumption; (b) utility consumption of at least one segment or appliance associated with a second facility, correlated to at least one designated parameter affecting utility consumption; (c) hypothetical utility consumption of said at least one segment or appliance associated with the first facility and operated according to optimized conditions; and (d) hypothetical utility consumption of a proposed replacement at least one segment or appliance that may be substituted for said at least one segment or associated with the first facility; (iii) comparing information derived from the at least one sensor with stored information indicative of at least one of (a), (b), (c), and (d) to generate comparison information; and (iv) performing at least one of storing and displaying said comparison information.

Other aspects, features and embodiments of the invention will be more fully apparent from the ensuing disclosure and appended claims.

### BRIEF DESCRIPTION OF THE DRAWINGS

FIG. 1 is a schematic diagram showing various independent and dependent factors affecting utility consumption and consumption cost.

FIG. 2 is a schematic diagram showing components and interconnections of a utility monitoring and managing system according to one embodiment of the present invention.

FIGS. 3A-3B embody three different contour-type utility signature maps for a given facility, highlighting different patterns of excess utility consumption.

FIG. 4A embodies a tabular utility signature map or utility consumption comparison table for the first facility populated with a first set of values.

FIG. 4B embodies a tabular utility signature map or utility consumption comparison table for the first facility populated with a second set of values.

FIG. 4C embodies a table identifying associated with operating an old refrigerator versus purchasing and operating a new refrigerator, with estimated payback time associated with the proposed upgrade.

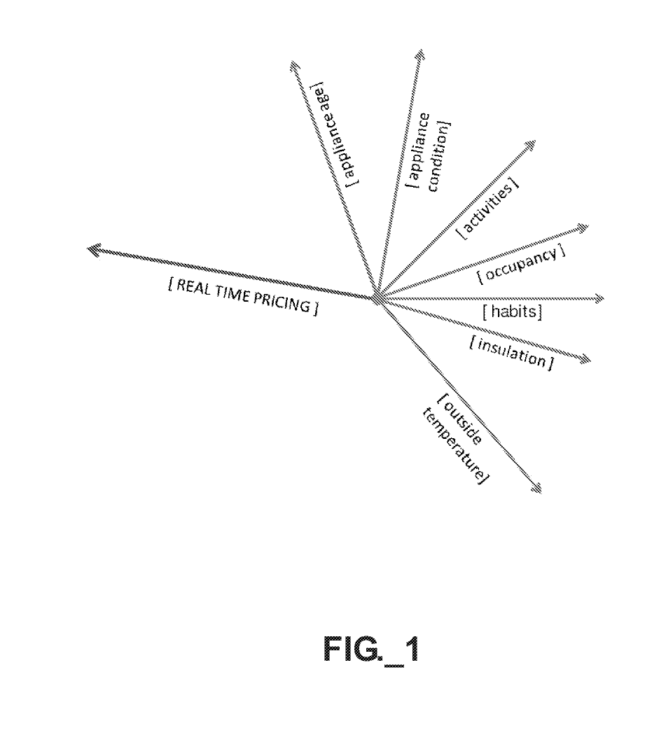

### DETAILED DESCRIPTION OF THE INVENTION AND PREFERRED EMBODIMENTS THEREOF

Various embodiments of present invention relate generally to the use of (A) one or more sensors arranged to monitor an operating condition and/or utility consumption of at least one segment or appliance of a first facility; (B) a memory including at least one of (i) stored utility consumption information correlated or normalized to at least one designated parameter affecting utility consumption or (ii) hypothetical utility consumption; (C) a processor to compare the monitored information with the stored information, and (D) an output medium to store and/or display the comparison information. The stored utility consumption information may relate to at least one segment or appliance of the first facility, or may relate to at least one segment or appliance of a second facility (with the second facility optionally representing a composite of many different facilities). The hypothetical utility consumption information may relate to at least one segment or appliance of the first facility and operated according to optimized conditions, or may relate to at least one segment or appliance that may be substituted for the least one segment or associated with the first facility.

As used herein, the term “utility” refers to a consumable resource such as (but not limited to) electric power, fuel (e.g., natural gas, hydrogen, propane, kerosene, diesel, gasoline, alcohol, distillates, and the like), water, chemicals, and the like. A utility is preferably supplied or flowed on a demand basis to an end use facility.

As used herein, the terms “utility-consuming segment” or “segment” refer to a material flow and/or dispensing circuit, electrical circuit, or the like, that is preferably associated with or isolated to a discrete zone of a facility (e.g., the first facility).

As used herein, the terms “utility-consuming appliance” or “appliance” refer to a controllable utility-consuming apparatus that may be associated with an entire facility (e.g., a HVAC system serving an entire facility) or associated with only a discrete portion thereof (e.g., a HVAC system serving only one zone of a multi-zone facility).

As used herein, the term “operating condition” refers to a physical property subject to being automatically monitored with at least one sensor, and characterizing a property in or around, and affecting utility consumption of, (a) at least one utility-consuming segment of a facility, (b) a utility-consuming appliance of a facility, and/or (c) a facility with which the at least one segment or appliance is associated. Operating conditions may include environmental properties, and conditions in or around at least one segment or appliance of a facility (including conditions created by such a segment or appliance, such as air or water flow, air or water temperature, and so on). Examples of operating conditions include, but are not limited to: ambient temperature, ambient humidity, incident light or radiation, rainfall, wind, material/air flow, thermal flux to or from the facility, pressure and differential pressure within the facility, indoor temperature, indoor humidity, thermal flux to the at least one segment or appliance.

As used herein, the terms “designated parameter affecting utility consumption” or “designated parameter” refers to a circumstance affecting utility consumption of, (a) at least one utility-consuming segment of a facility, (b) a utility-consuming appliance of a facility, and/or (c) a facility with which the at least one segment or appliance is associated. A designated parameter may include an operating condition (as defined hereinabove), an operating condition relating to at least one segment or appliance, and/or a characteristic state or property of the at least one segment or appliance. Examples of designated parameters include, but are not limited to: ambient temperature; ambient humidity; incident light or radiation; air flow; thermal flux to or from the facility, segment, and/or appliance; size of the facility, segment, and/or appliance; age of the facility, segment, and/or appliance; utility efficiency estimate or rating for the facility, segment, and/or appliance; usage or occupancy duration of the facility, segment, and/or appliance; operating setpoint of the segment or appliance; maintenance state of the segment or appliance; corrosion or fouling of the segment or appliance; and so on. Values for designated parameters may be obtained from sensors, from appurtenant systems (e.g., via interconnect to a security to determine occupancy of a facility or segment), or from one or more user or administrator input devices.

As used herein, the phrase “historical utility consumption” refers to utility consumption over any desirable time period in the past. Values may be subjected to statistical adjustment, such as averaged over a desired interval, and outlying values considered to be erroneous may be excluded if desired. Historical utility consumption data is preferably normalized or correlated to at least one designated parameter affecting utility consumption.

As used herein, the phrase “operated according to optimized conditions,” as applied to at least one segment or appliance, refers to operation with controllable parameters set to the values or states likely to result in reduced utility consumption and/or reduced utility consumption cost. Examples of controllable parameters subject to optimization include: operating time or duration of the segment or appliance; operating setpoint of the segment or appliance; maintenance state of the segment or appliance, and the like.

It is commonplace for utility suppliers to provide utility users with periodic (e.g., monthly) cumulative utility usage information aggregated for all segments an entire facility. As such aggregated facility-wide information does not provide usage information for specific segments or appliances associated with a facility, it is of limited value for a user to diagnose wasteful operation of any specific segment or appliance. Furthermore, as such aggregated facility-wide information is not normalized with respect to numerous variables that may affect usage for any particular operating period, it is of limited value for a user to assess whether aggregated usage is “normal” under the circumstances, or whether such usage has been substantially wasteful. One or more of the foregoing limitations—including inability to provide sufficiently detailed information regarding specific segments or appliances associated with a facility, and inability to correlate or normalize usage patterns to designated parameters affecting utility usage—are overcome with embodiments of the present invention.

Consumption information for specific segments or appliances associated with a facility may be obtained using segment-specific or appliance-specific utility consumption sensors. Such utility consumption sensors may communicate information, via wired or wireless communication, to be stored in a memory or data repository. In one embodiment directed to monitoring and/or managing electric power consumption, current sensors (e.g., inductive-type) may be provided on individual conductors downstream of a main electrical circuit breaker associated with a particular facility. In this manner, power consumption by specific segments (e.g., circuits) and/or appliances associated with the facility may be monitored separately. This permits a problem specific to a single segment or appliance to be identified more easily, and therefore enables such problem to be more easily corrected. Embodiments directed to other utilities (e.g., water, gas, chemicals) may utilize suitable sensors (e.g., flow sensors) associated with specific segments or appliances to be monitored. A plurality of utility consumption sensors, including sensors applied to different segments or appliances, redundant sensors, and/or sensors of different types, may be used.

In one embodiment, at least one sensor is used to monitor at least one operating condition in or around, and affecting utility consumption of, (a) at least one utility-consuming segment of a facility, (b) a utility-consuming appliance of a facility, and/or (c) a facility with which the at least one segment or appliance is associated. Such operating condition sensor(s) are desirable used to correlate or normalize usage patterns to designated parameters affecting utility usage. In one embodiment, a plurality of environmental properties is monitored with a plurality of sensors. A plurality of operating condition sensors, including sensors applied to different segments or appliances, redundant sensors, and/or sensors of different types, may be used. Various sensors may be located within a facility or outside a facility. Signals from multiple sensors of similar types may be compared or averaged. Logging of utility consumption and one or more designated parameters with respect to time may be used to generate a correlation or functional relationship between utility consumption and such parameter(s). This permits intelligent comparison between newly gathered utility consumption data and historical data, as it can show whether high utility consumption in any given time period “normal” under the circumstances. Deviation from an established functional relationship between utility consumption and at least one designated parameter may be used to highlight potential problems (e.g., an appliance or segment needing service or replacement). Identification of problems in this regard facilitates more rapid correction of same, thus reducing wasteful utility consumption.

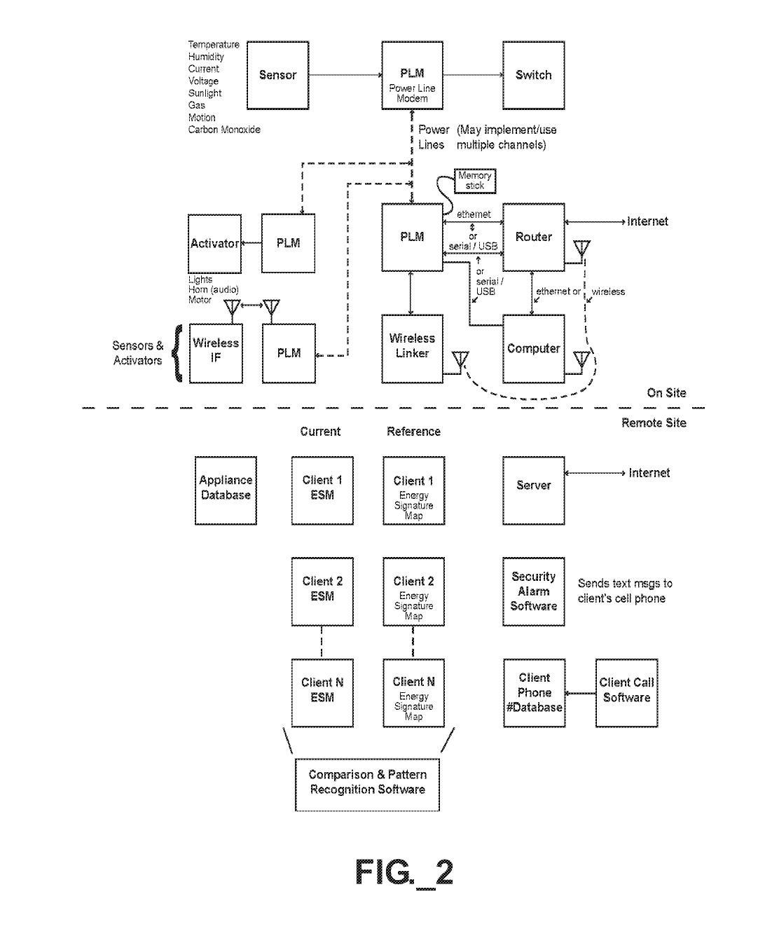

A schematic diagram for a system according to one embodiment of the present invention is shown in FIG. 2. The system includes certain elements arranged for installation at or near a first utility-consuming facility (“on-site” portion), and other elements arranged for installation remotely from such facility (“off-site” portion). The on-site portion of the system may include sensors, switches, and activators operatively connected to a local data transfer or communication element preferably including a memory element. The local data transfer or communication element (which may be embodied in a power line modem) may have an associated router operatively connected to a data network (e.g., the Internet), and the computer may provide user input and display capability. The local data transfer or communication element preferably includes a local memory, which may be embodied in a removable memory stick or the like. Various sensors may be used, for example, to monitor utility consumption of one or more segments or appliances (e.g., by measuring electric current or gas flow), to monitor performance of one or more segments or appliances (e.g., by measuring carbon monoxide proximate to a combustion appliance), and/or to monitor operating conditions such as temperature, humidity, incident radiation (sunlight), motion (as relating to occupancy of a facility or portion thereof), etc. One or more activators or output elements may also be operatively connected to utility consuming segments or appliances within the facility to enable remote control and/or feedback control capabilities. Such remote control capability may include one or more conditional authorization steps, to enable a user to approve an action (e.g., modification of a setpoint, activation or deactivation of an appliance, etc.) proposed by a utility management system according to the present invention.

Various elements within the system may be connected via wired or wireless links (e.g., wirelessly using telephony, ZigBee, WiFi, WiMax, Bluetooth, or the like; or via wired using telephony, broadband-over-powerline, DSL, cable modem, etc.). In one embodiment, a first memory is provided at or near the facility to store information accumulated over a specified period (e.g., a day, a week, a month, etc.) and a second memory (or data repository) is provided remotely to receive periodic transfer of information obtained from the first memory. Any suitable type of memory (e.g., non-volatile memory, flash memory, hard drive, etc.) may be used.

Power line modems may be desirably used to connect one or more sensors, activators, and switches to the local data transfer or communication element. Wired connections such as Ethernet, Universal Serial Bus, other serial connections, or the like may be used to connect the local data transfer or communication element with the router and/or computer. The off-site portion of the system may include a server arranged to communicate with the router, and a database containing stored information subject to retrieval to permit data comparison (preferably correlated or normalized data comparison). The server (or another dedicated computer) is preferably arranged to run comparison and/or pattern recognition software to enable comparison between (a) information received from the on-site portion of the system via the router, and (b) information stored in the database. Examples of comparisons that may be made include: (i) comparison between recently obtained utility consumption data for the first facility and historical utility consumption data for the first facility—preferably parsed into specific segments or appliances of the first facility, and/or normalized or correlated to at least one designated parameter; (ii) comparison between utility consumption of at least one segment or appliance of the first facility and utility consumption of at least one segment or appliance of a second facility (which may represent a composite or average of multiple facilities), preferably parsed into specific segments or appliances of the respective facilities, and/or normalized or correlated to at least one designated parameter; (iii) comparison between actual consumption of at least one segment or appliance associated with the first facility and hypothetical consumption of at least one segment or appliance associated with the first facility operated according to optimized conditions; and (iv) comparison between actual consumption of at least one segment or appliance associated with the first facility and hypothetical consumption of a proposed replacement at least one segment or appliance that may be substituted for said at least one segment or associated with the first facility. Alarms or alerts according to pre-programmed or user-defined energy consumption thresholds or unusual consumption conditions may be communicated to an end user (client) via telephone or instant message software arranged to communicate with a telephone or portable device operated by the end user. As various conditions are already being sensed at the first facility, facility security capabilities may be integrated into the system. Motion, intrusion, and/or glass breakage may be sensed at the first facility (on-site) and communicated via the router to a remote (off-site) portion, with automatic notification to be sent to the client and/or law enforcement officials.

In one embodiment, utility usage may be monitored for at least one appliance or segment of a facility, such information may be stored on a time-dependent basis (preferably together with at least one designated parameter to which usage information may be correlated or normalized), and the resulting information may be used to generate a utility signature map. In one embodiment, a utility signature map may represent utility usage as a function of different appliances or segments associated with a facility. In a further embodiment, a selected (e.g., recent) utility signature map may be overlaid or compared to one or more prior utility signature maps, one or more composite (e.g., time-averaged) utility signature maps, and/or one or more normalized utility signature map embodying correlation to one or more designated parameters, in order to generate at least one comparative utility signature map (CUSM).

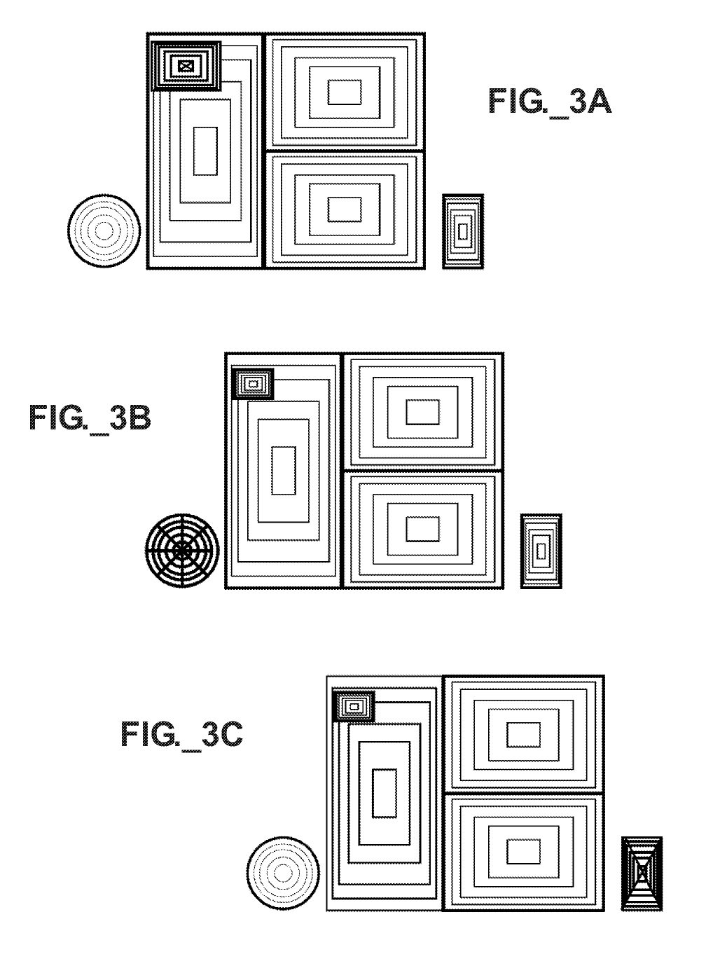

A CUSM may be generated in any of various formats. In one embodiment, a CUSM may be provided as a contour map of a facility such as a home showing which area or areas are consuming utilities at a higher than normal or higher than optimal rate. FIGS. 3A-3C embody different CUSMs according to one embodiment, with each Figure showing a different segment or appliance exhibiting abnormally high utility consumption. In FIG. 3A, a refrigerator (rectangle at upper left) is highlighted by larger size and darker contour lines to show that this appliance is consuming a utility (electric power) at an unusually high rate as compared to a particular reference. In FIG. 3B, an air conditioning unit (circle at lower left) is highlighted to show that this appliance is consuming a utility (electric power) at an unusually high rate as compared to a particular reference. In FIG. 3C, a furnace (rectangle at lower right) is highlighted to show that this appliance is consuming a utility (natural gas) at an unusually high rate as compared to a particular reference. In these embodiments, changes in the contour lines would represent higher than average usage and consumption. Color, animation, or other indicators could be used. Representations of normal or abnormal usage may be configured by a user.

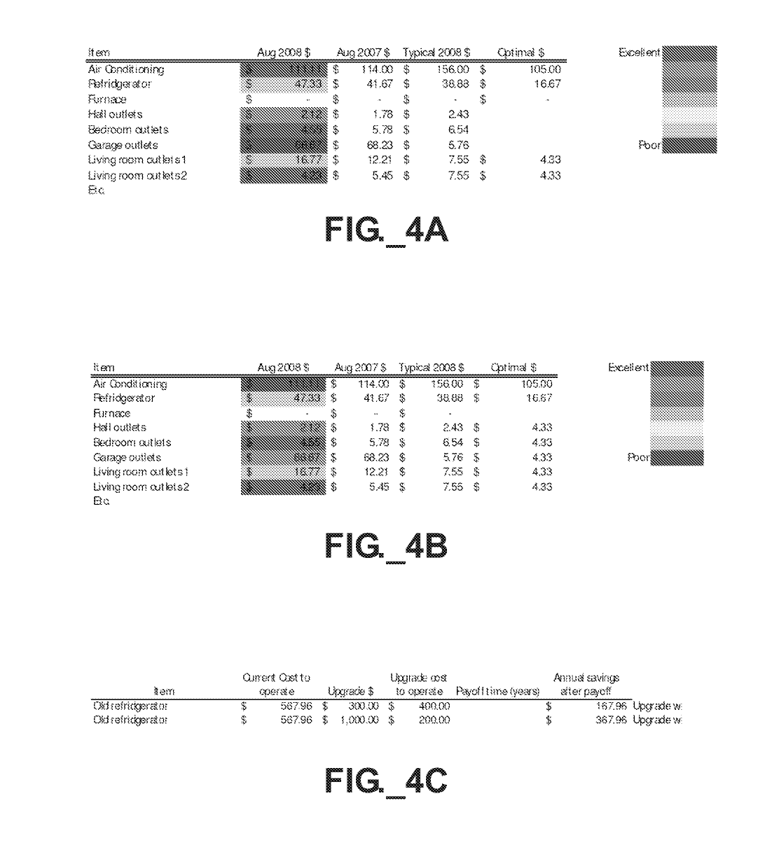

In another embodiment, a CUSM may be provided as a heat map. In yet another embodiment, CUSM information can be provided in tabular formats, such as shown in FIGS. 4A-4C.

In one embodiment, comparison information such as a CUSM is provided in an interactive format (e.g., via an interactive display such as a personal computer or handheld communication device) to permit an individual to enter one or more designated parameter into a user interface to generate a CUSM tailored to the specific parameter(s). In one embodiment, a user may enter information into an interactive device to aid in system utilization, or to enable performance of utility consumption comparison studies. For example, a user may enter information indicating which days a facility is not expected to be occupied (such as when a business is closed or a family is on vacation), as such usage may impact utility consumption. In another embodiment, data may be extracted from a separate database to provide system input information or enable comparison of utility consumption patterns. For example, a system may extract data from a security monitoring service indicating when a security system for a specific facility has been engaged, thus indicating that the facility was not occupied for the duration of the security system engagement.

In an embodiment directed to monitoring or management electrical energy usage for air conditioning (cooling) at a particular facility, sensors for ambient outdoor temperature and humidity may be used, as well as a sensor measuring current supplied to an air conditioning appliance, with data from such sensors being logged together with respect to time to permit electrical power consumption to be correlated to temperature and/or humidity. Such correlated data may be used to establish a functional relationship or trend between electrical power consumption for air conditioning and temperature and/or humidity. Recent month electric power usage for the air conditioning unit correlated to temperature and/or humidity may be compared to historical power usage correlated to the same designated parameter(s). Such comparison may be stored and preferably displayed on an output medium (e.g., paper, electronic mail, instant message, or the like) to provide information to an end user. Departure from an established functional relationship or trend may be used to indicate a problem with the air conditioning appliance—such as to identify a need to service, repair, or replace the unit.

In certain embodiments, systems according to the present invention may enable comparison between utility consumption of a first facility versus utility consumption for one or more other facilities of comparable size, age, etc. Upon display of such information, a user can easily compare a utility consumption profile or pattern for one facility to similar profiles or patterns generated for other facilities.

In another embodiment, systems according to the present invention may enable comparison between actual utility consumption for at least one segment or appliance of a first facility and (1) hypothetical consumption for the segment or appliance of the facility operated according to optimized conditions (e.g., operated according to different setpoint, or following servicing or repair), or (2) hypothetical consumption for a replacement segment (e.g., including enhanced insulation or sealing) or replacement appliance.

In certain embodiments, systems and methods according to the present invention can automatically calculate the cost of operation of all separately monitored items on the entire network. Cost information may then be communicated to the user so to identify monetary impact to the user of operating habits, old appliances, malfunctioning appliances, and the like. A system may then generate and communicate to the user an estimate of monetary savings that may be realized by changing sub-optimal operating habits, servicing or repairing an appliance or utility-consuming segment, or replacing an appliance or segment with a more efficient unit. If upgrades and/or maintenance are required, a system according to the present invention may automatically calculate the payback time associated with such an event. By calculating the monetary impact of inefficient utility usage and presenting the user with information regarding same, systems and methods according to the present invention greatly increase the likelihood that users will take action to improve efficiency. Systems and methods according to the present invention thus enable easy optimization of energy consumption.

Substantial information about utility consumption of a particular facility may be inferred automatically using the systems according to the present invention. Automatic identification and presentation of likely scenarios will greatly assist the average consumer lacking technology orientation.

As shown in FIG. 4A, color coding may be applied to rate utility consumption costs for specific appliances or segments (e.g., electric circuits) with a facility, with a legend provided at right. The highest (“excellent”) rating is assigned a dark blue color code, and the lowest (“poor”) rating is assigned a red color code, with intermediate ratings ranging in order from light blue, dark green, light green, yellow, and then orange (leading to red). Hypothetical data is displayed in tabular format in FIG. 4A. Through the use of color coding and an appropriate legend, a user can quickly see that his facility's air conditioning system is operating in a near optimal state (excellent rating). In this case, the system has calculated an “optimal” usage (taking into account the user's temperature setpoint, comparable usage for a highly SEER rated air-conditioning system with recommended insulation for a comparable facility in the user's climate and/or utility area) and presented such information at far right. Data for typical users (i.e., preferably normalized or correlated to at least one designated parameter) is also presented to the left of the optimal value. As utility consumption for the user's air conditioning system ($111.11 for August 2008) does not substantially exceed the hypothetical optimal value ($105.00 for the same period), it is easily perceived that the user facility's air-conditioning system exhibits excellent performance under the circumstances.

FIG. 4A also makes quite clear that user's facility has unusually high energy consumption attributed to garage outlets ($66.67 in August 2008). Not only is the usage for the most recent period high as compared to an optimal situation, but also the garage outlet segment of this particular facility has exhibited high utility consumption both currently and historically against average consumers. From this information, it may be assumed that the user's facility has a very poorly performing appliance associated with the garage outlets. Additionally, the user can quickly visualize that no matter the nature of the problem associated with the garage outlets, such problem is costing the user over $60 per month (i.e., as compared to optimal usage).

Consider utility usage associated with the first facility refrigerator in FIG. 4A. Substantial useful information is presented. In this case, the first facility refrigerator is operating fairly poorly as compared against an optimal refrigerator. Thus, it might initially be assumed that there something may be wrong with the first facility refrigerator. Upon comparing utility usage of the first facility refrigerator against refrigerator utility consumption of typical users (which number may be an average or composite of consumption at many different facilities), it may be seen that the utility consumption associated with the first facility usage is not that poor. This scenario would suggest that the first facility refrigerator is not highly energy efficient, but may likely be operating close to original specifications.

In a preferred embodiment, a user may interact with a comparison data interface to provide enhanced utility. Consider the data presented in FIG. 4A, which may be displayed on a monitor of a networked personal computer or a communication-enabled handheld device, such as via a Web browser or similar interface. Using any desirable interface device, a user may interact with the comparison interface. Upon interaction by the user with the data interface, a number of questions may be generated and presented to the user. For example, based on the data contained in FIG. 4, the following queries may be presented to the user:

1. Did you go on vacation in August 2008 and if so for how long?

2. Did you go on vacation in August 2007 and if so for how long?

3. Do you have an old refrigerator in your garage?

4. Would you like to see how much a new refrigerator will save you each year?

The user chooses to answer and inputs the following (preferably from a pre-configured input menu):

1. Yes, for 2 weeks. Turned off air while gone.

2. No

3. No

4. Yes

In a further step, the user is presented with further queries and inputs information specifying that the first facility garage includes a woodworking shop that is utilized on weekends.

Based on this information, the comparison information may be updated and re-presented to the user (see FIG. 4B). Given the user's interaction with the system noting that the garage outlet does not correspond to a poorly operating appliance and thus does not represent a problem, the system has recoded the garage outlet consumption as light blue, and thus no longer alert the user that the garage outlet utility consumption is unusually high—unless such usage should significantly increase above historical baseline usage for the garage outlets. Also, the utility usage for the first facility air conditioning system is now presented in red to indicate that the usage is unusually high—thus reflecting a high likelihood that malfunction may exist with the first facility's air-conditioning system. Examination of historical data for August 2007 suggests that the first facility's air conditioning and insulation were close to optimal, but the August 2008 utility consumption was exceptionally high given that the air conditioning system was activated for only half of the month. The comparison system would then alert the user to have the first facility air-conditioning system serviced, and further calculate the additional periodic (e.g., annual) wasted cost associated with continue operation if corrective action should not be implemented.

Systems and methods according to the present invention may embody additional intelligent features. As indicated previously, in order to map/compare usage and appliance function, at least one designated parameter may be used to correlate or normalize utility consumption for a segment or appliance associated with a first facility to any of: historical utility consumption for a segment or appliance associated with the first facility, utility consumption for a segment or appliance associated with a second facility, utility consumption for a segment or appliance associated with a hypothetical or idealized facility. Monitored conditions may include outside temperature and humidity, incident light or radiation, rainfall, wind, pressure and differential pressure within a facility, inside temperature and humidity, and so on. Correlation or normalization to similar conditions enables meaningful comparisons to be made without being based on potentially skewed utility consumption data. Data gathering and processing portions of a systems and methods according to the present invention may further incorporate ‘learning’ capability based on historical data to identify, characterize, and/or present functional relationships between utility consumption patterns and factors such as heat generated inside a facility (e.g., from equipment and people), thermal gradients, power consumption by circuit, and so on. Such presentation may be in the form of one or more comparative utility signature maps.

Consider the desirability of maintaining optimal operation of an air conditioning unit. A simple method for diagnosing air conditioner operation is to measure the differential temperature across the condenser or evaporator. Utility management systems and methods according to the present invention may include temperature sensors proximate to the inlet and outlet of an air conditioner condenser or evaporator, and differential temperature information may be logged as a function of time to augment presentation of utility consumption information Additionally, air flow monitoring elements could be installed for each air conditioning unit associated with a facility, and the air flow may be compared with historic levels to indicate whether a particular unit requires cleaning or a new filter. Ambient temperature within the facility and outside the facility, humidity, incident light or radiation, and similar factors can also be logged as a function of time to provide further useful utility consumption and/or appliance condition information as may be considered in developing functional relationships based on designated parameters.

In one embodiment, utility management systems and methods according to the present invention may utilize one or more switches or output devices to enable automated optimization and/or control of utility consumption. Switches or other output devices may be arranged at various portions in or around a utility consumption facility, and a utility management system may remotely turn off certain circuits, appliances, etc. based on user-defined instructions or other inputs. In one embodiment, utility management system includes capability to remotely display to a user which appliances or segments (e.g., electric circuits) are activated within a facility, and enabling user to adjust, deactivate, or activate specific appliances or segments. Additionally, a user may instruct the system to automatically deactivate certain appliances or segments based on specified conditions, such as ambient temperature, time of day or day of the week, light conditions, etc.

For example, a user may want to maintain a facility cooled to a specified temperature window in the summertime even when the facility is not occupied. However, the user may desire that a utility management system determine temperature conditions outside or inside the facility, and only allow the air conditioning to run if the specified temperature(s) exceed certain thresholds. Such operation may be automatically implemented with a system according to the present invention.

In one embodiment, utility management systems and methods include capability to automatically generate and “push” to a user information to enable remote control. For example, systems and methods according to the present invention may include production of daily, weekly, and monthly comparisons for a given facility. Information may then be presented to a user in a proactive format (such as an email or text message) when a usage over a particular interval seems at odds with historical patterns. For example, assume that a business facility has a weekly pattern of electricity usage wherein the air conditioning and lights are routinely operated on weekdays from 8:00 AM to 7:00 PM for a three-month period. Such pattern of usage may be recognized by the utility management system. If the system detects operation of air conditioning or lights at the facility outside of routine operating hours, the system may alert the user of such unusual operation and provide the user opportunity to take action corrective action remotely.

In one embodiment, an appliance that utilizes multiple different utilities (e.g., a gas furnace, which may burn natural gas to produce heat but also utilize electric power to operate an air blower) may be monitored with respect to consumption of a first utility (e.g., electric power), and such first utility consumption may be used to infer consumption of the second utility (e.g., gas). This may be desirable when the ratio of usage of the first and second utilities is relatively constant, and when it is simpler to monitor one utility (such as electric power) than another (e.g., flow of a physical medium such as fuel, water, chemical, or the like). Other similar conversions are also envisioned.

Various advantages and features of the invention are further illustrated with reference to the following examples, which are not to be construed as in any way limiting the scope of the invention but rather as illustrative of embodiments of the invention in specific applications thereof.

### Example 1

Consider a first facility having an air-conditioning system that is low on refrigerant. In this case, the air conditioning system will have to be operated much more frequently than would be the case if the refrigerant were not partially depleted. A utility management system as described herein monitors the frequency with which the air conditioning is operated. The management system may then compare the current electric power consumption, normalized or correlated to ambient temperature and humidity, against historical electric power consumption information recorded for the same air-conditioning system in the past, similarly normalized or correlated to ambient temperature and humidity. Comparison information is then generated and presented to the user to demonstrate the degree of wasteful electric power usage and/or cost, with a calculation of current operating cost of the air-conditioning system versus cost incurred on similar days with similar climate. Further correlation or normalization may be performed to account for any differences in temperature set point. The utility management system then automatically identifies a listing of potential problems that may be contributing to the problem.

In this case, a user may be able to try to implement one or more easy fixes (like cleaning the air conditioning system or changing filters) and thereafter (e.g., within a few days) initiate generation of a new utility consumption comparison. The user implemented fix may cure the problem. However, additional work may be required if the utility consumption comparison continues to reflect excess utility consumption for the specified conditions. A similar approach may be applied to other appliances and/or utilities.

### Example 2

In another example, a facility such as a house includes a very old refrigerator operating in the garage to chill drinks A utility management system according to the present invention monitors electric usage specific to either the refrigerator or an entire garage circuit. The refrigerator condenser will exhibit regular cyclic operation that can easily be discerned from other garage consumption. The utility management system may then identify to the user how much the refrigerator is costing to operate. Additionally, the utility management system may further identify to the user the costs to acquire and operate a newer, more efficient refrigerator, thus allowing the users to easily make an economically informed decision to promote reduced utility consumption.

### Example 3

Many utility consumers mistakenly believe it is more economical to operate an air conditioning unit (perhaps at a slightly elevated temperature) even when the facility to be cooled is not occupied so that the air conditioning system is not pressed to work too hard when the facility is to be cooled. In this example, a user interacts with a utility management system according to the present invention to generate a daily comparative utility signature map to determine economic effects of different operating habits. On a first day, the user operates the air-conditioning unit as usual and generates a first utility consumption profile. On a second day, the user then turns off the air-conditioning unit during the day, resumes operation of the air conditioning in the early evening and generates a second utility consumption profile. A comparative profile would then be generate to include the following information:

| Item | Daily rate |
|---|---|
| Operating AC while user out | $12.32 |
| Deactivating AC while user out | $7.54 |
| Yearly savings | $573.60 |

### Example 4

This example highlights usage of a utility management system as described herein to demonstrate to a user the cost savings that may be realized by operating appliances at different settings (setpoints). On a first day, the user operates an air conditioning unit at a normal temperature setpoint (e.g., 70° F.). The utility management system calculates energy cost attributable to the air conditioning unit. On a second day of similar ambient conditions to the first day, the user then operates the air conditioning unit at a different temperature setpoint (e.g., 70° F.). The utility management system generates an electric power consumption comparison that enables the user to easily make economically informed decisions about operating the air conditioning system as a function of temperature setpoint.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. One or more individual features described in conjunction with specific embodiments and examples may be combined with one or more features of other embodiments and examples in various combinations and permutations as necessary to achieve a desired result. Correspondingly, the invention as hereinafter claimed is intended to be broadly construed and interpreted, as including all such variations, modifications and alternative embodiments, within its spirit and scope.

1. A system comprising:
at least one sensor arranged to monitor any of an operating condition and utility consumption of at least one utility-consuming segment or appliance associated with a first facility;
a memory including stored information indicative at least one of the following items:
(a) historical utility consumption of said at least one segment or appliance associated with the first facility, correlated to at least one designated parameter affecting utility consumption;
(b) utility consumption of at least one segment or appliance associated with a second facility, correlated to at least one designated parameter affecting utility consumption;
(c) hypothetical utility consumption of said at least one segment or appliance associated with the first facility and operated according to optimized conditions; and
(d) hypothetical utility consumption of a proposed replacement at least one segment or appliance that may be substituted for said at least one segment or associated with the first facility;
a processor operatively arranged (i) to receive information derived from the at least one sensor, and (ii) to compare the monitored information with the stored information so as to generate comparison information; and
an output medium arranged to store and/or display said comparison information.

2. The system of claim 1, wherein the stored information is indicative of (a) historical utility consumption of said at least one segment or appliance associated with the first facility, correlated to at least one designated parameter affecting utility consumption.

3. The system of claim 2, wherein the at least one designated parameter comprises any of ambient temperature, ambient humidity, thermal flux to or from at least one segment of the first facility, first facility occupancy, first facility appliance usage, and first facility appliance operating setpoint.

4. The system of claim 1, wherein the stored information is indicative of (b) utility consumption of at least one segment or appliance associated with the second facility, correlated to at least one designated parameter affecting utility consumption.

5. The system of claim 4, wherein the at least one designated parameter affecting utility consumption comprises any of ambient temperature, ambient humidity, thermal flux to or from at least one segment of the second facility, second facility occupancy, second facility appliance usage, second facility appliance operating setpoint, second facility size, second facility age, second facility utility efficiency estimate or rating, second facility appliance size, second facility appliance age, and second facility appliance utility efficiency estimate or rating.

6. The system of claim 1, wherein the stored information is indicative of (c) hypothetical utility consumption of said at least one segment or appliance associated with the first facility and operated according to optimized conditions.

7. The system of claim 1, wherein the stored information is indicative of at least two of items (a) to (d).

8. (canceled)

9. The system of claim 1, wherein the at least one sensor is arranged to monitor an operating condition comprising at least one of ambient temperature, ambient humidity, incident light or radiation, rainfall, wind, material/air flow, thermal flux to or from the facility, pressure and differential pressure within the facility, indoor temperature, indoor humidity, and thermal flux to the at least one segment or appliance.

10-13. (canceled)

14. The system of claim 1, further comprising an input device arranged to receive information relating to said at least one designated parameter affecting utility consumption.

15. The system of claim 1, wherein the at least one utility-consuming segment or appliance associated with the first facility comprises an electrical circuit arranged downstream of a main electrical circuit breaker associated with the first facility.

16. (canceled)

17. The system of claim 1, the at least one utility-consuming segment or appliance comprises an appliance selected from the group consisting of an air heating unit, an air cooling unit, a ventilation unit, a heat pump, and an air conditioning unit.

18. The system of claim 1, wherein said utility consumption comprises electrical power consumption.

19-21. (canceled)

22. The system of claim 1, wherein said comparison information includes information indicative of at least one of the following:
(a) potential utility consumption savings or utility consumption cost savings that may be realized by implementing operational changes for the at least one segment or appliance associated with the first facility;
(b) potential utility consumption savings or utility consumption cost savings that may be realized by servicing the at least one segment or appliance; and
(c) potential utility consumption savings or utility consumption cost savings that may be realized by upgrading the at least one segment or appliance.

23. (canceled)

24. The system of claim 1, further comprising an activator or output element arranged to control or adjust operation of the at least one segment or appliance responsive to said comparison information or user permission issued after receipt of said comparison information.

25. (canceled)

26. A method for performing at least one of utility consumption monitoring and management, the method comprising:
monitoring, with at least one sensor, any of an operating condition and utility consumption of at least one utility-consuming segment or appliance associated with a first facility;
storing information indicative of at least one of the following:
(a) historical utility consumption of said at least one segment or appliance associated with the first facility, correlated to at least one designated parameter affecting utility consumption;
(b) utility consumption of at least one segment or appliance associated with a second facility, correlated to at least one designated parameter affecting utility consumption;
(c) hypothetical utility consumption of said at least one segment or appliance associated with the first facility and operated according to optimized conditions; and
(d) hypothetical utility consumption of a proposed replacement at least one segment or appliance that may be substituted for said at least one segment or associated with the first facility;
comparing information derived from the at least one sensor with stored information indicative of at least one of (a), (b), (c), and (d) to generate comparison information; and
performing at least one of storing and displaying said comparison information.

27. The method of claim 26, wherein the stored information is indicative of (a) historical utility consumption of said at least one segment or appliance associated with the first facility, correlated to at least one designated parameter affecting utility consumption.

28. The method of claim 27, wherein the at least one designated parameter comprises any of ambient temperature, ambient humidity, thermal flux to or from at least one segment of the first facility, first facility occupancy, first facility appliance usage, and first facility appliance operating setpoint.

29. The method of claim 26, wherein the stored information is indicative of (b) utility consumption of at least one segment or appliance associated with a second facility, correlated to at least one designated parameter affecting utility consumption.

30. The method of claim 29, wherein the at least one designated parameter comprises any of ambient temperature, ambient humidity, thermal flux to or from at least one segment of the second facility, second facility occupancy, second facility appliance usage, second facility appliance operating setpoint, second facility size, second facility age, second facility utility efficiency estimate or rating, second facility appliance size, second facility appliance age, and second facility appliance utility efficiency estimate or rating.

31. The method of claim 26, wherein the stored information is indicative of (c) hypothetical utility consumption of said at least one segment or appliance associated with the first facility and operated according to optimized conditions.

32. The method of claim 26, wherein the stored information is indicative of at least two of items (a) to (d).

33-36. (canceled)

37. The method of claim 26, wherein the at least one sensor is arranged to monitor utility consumption of the at least one segment or appliance associated with the first facility.

38. (canceled)

39. The method of claim 26, wherein the at least one utility-consuming segment or appliance associated with the first facility comprises an electrical circuit arranged downstream of a main electrical circuit breaker associated with the first facility.

40-41. (canceled)

42. The method of claim 26, wherein said utility consumption comprises electrical power consumption.

43-47. (canceled)

48. The method of claim 26, further comprising the step of controlling or adjusting operation of the at least one segment or appliance responsive to said comparison information or user permission issued after receipt of said comparison information.

49. The method of claim 26, wherein the storing step is performed utilizing a computer-readable memory, the comparing step is performed utilizing a processor, and at least two steps of the method are performed automatically according to machine-readable instructions.
